(19) United States
(12) Patent Application Publication
(10) Pub. No.: US 2020/0024993 A1
(43) Pub. Date: Jan. 23, 2020

(54) GAS TURBINE ENGINE COMBUSTION ARRANGEMENT AND A GAS TURBINE ENGINE

(71) Applicant: ROLLS-ROYCE PLC, London (GB)

(72) Inventors: Prabhu I.S KUMAR, Bengalore (IN); Thomas G. MULCAIRE, Derby (GB); Dasthagiri R. THUMMALURU, Bengaluru (IN)

(73) Assignee: ROLLS-ROYCE PLC, London (GB)

(21) Appl. No.: 16/294,211

(22) Filed: Mar. 6, 2019

(30) Foreign Application Priority Data
Mar. 6, 2018 (IN) 201811008200

(51) Int. Cl. F01D 9/04; F23R 3/50; F01D 11/00

(52) U.S. Cl. CPC F01D 9/041; F23R 3/50; F05D 2240/12; F05D 2240/56; F01D 11/005

(57) ABSTRACT

A gas turbine engine combustion arrangement includes an annular combustion chamber, an annular discharge nozzle, an array of turbine nozzle guide vanes and an annular casing. The nozzle is between the downstream end of an outer annular wall of the annular combustion chamber and the array of turbine nozzle guide vanes. The annular casing surrounds the annular combustion chamber, the annular discharge nozzle and the array of turbine nozzle guide vanes. The upstream end of the annular discharge nozzle has an annular axially extending slot and the downstream end of the outer annular wall of the annular combustion chamber locates in the annular axially extending slot in the upstream end of the nozzle. The upstream ends of the radially outer platforms of the turbine nozzle guide vanes are adjacent the downstream end of the annular discharge nozzle and a support structure is connected to the nozzle and the annular casing.

The present disclosure concerns a gas turbine engine combustion arrangement and a gas turbine engine.

A known gas turbine engine combustion arrangement comprises an annular combustion chamber, an annular discharge nozzle and an array of turbine nozzle guide vanes. The annular combustion chamber comprises an outer annular wall and the outer annular wall of the annular combustion chamber has a downstream end. The array of turbine nozzle guide vanes have radially outer platforms and the array of turbine nozzle guide vanes is located downstream of the annular combustion chamber. The annular discharge nozzle is located between the downstream end of the outer annular wall of the annular combustion chamber and the array of turbine nozzle guide vanes. The annular discharge nozzle having an upstream end and a downstream end and the upstream end of the annular discharge nozzle has an annular axially extending slot and the downstream end of the outer annular wall of the annular combustion chamber locates in the annular axially extending slot in the upstream end of the annular discharge nozzle. The radially outer platforms of the turbine nozzle guide vanes having upstream ends and the upstream ends of the radially outer platforms of the turbine nozzle guide vanes are positioned adjacent the downstream end of the annular discharge nozzle. A support structure is connected to the annular discharge nozzle and the support structure has an annular radially extending slot, the radially outer platforms of the turbine nozzle guide vanes have radially extending flanges and the radially extending flanges of the turbine nozzle guide vanes locate in the annular radially extending slot in the support structure.

However, this gas turbine engine combustion arrangement has a problem in that the radially extending flanges of the turbine nozzle guide vanes may become disengaged from the radially extending slot in the support structure. This may result in the leakage of cooling air due to an increase in an axial gap between the upstream ends of the radially outer platforms of the turbine nozzle guide vanes and the downstream end of the annular discharge nozzle producing a cold spot or cold spots. Additionally, an experienced fitter and a laborious assembly technique are required to assemble, or disassemble, the support structure onto the turbine nozzle guide vanes to ensure that the support structure is not damaged. After assembly boroscope inspection of the arrangement is required to ensure that the flanges of the turbine nozzle guide vanes are located in the radially extending slot in the support structure. Additionally, the support structure and discharge nozzle may only be used once due to wear produced due to the relative movement between the flanges of the turbine nozzle guide vanes and the radially extending slot in the support structure and because the support structure comprises a bonded, brazed or welded, sheet metal construction which is bonded, brazed or welded to the discharge nozzle.

According to a first aspect there is provided a gas turbine engine combustion arrangement comprising an annular combustion chamber, an annular discharge nozzle, an array of turbine nozzle guide vanes and an annular casing, the annular combustion chamber comprising an outer annular wall, the outer annular wall of the annular combustion chamber having a downstream end, the array of turbine nozzle guide vanes having radially outer platforms, the array of turbine nozzle guide vanes being located downstream of the annular combustion chamber, the annular discharge nozzle being located between the downstream end of the outer annular wall of the annular combustion chamber and the array of turbine nozzle guide vanes, the annular casing surrounding and being spaced radially from the annular combustion chamber, the annular discharge nozzle and the array of turbine nozzle guide vanes, the annular discharge nozzle having an upstream end and a downstream end, the upstream end of the annular discharge nozzle having an annular axially extending slot, the downstream end of the outer annular wall of the annular combustion chamber locating in the annular axially extending slot in the upstream end of the annular discharge nozzle, the radially outer platforms of the turbine nozzle guide vanes having upstream ends, the upstream ends of the radially outer platforms of the turbine nozzle guide vanes being positioned adjacent the downstream end of the annular discharge nozzle and a support structure being connected to the annular discharge nozzle and the annular casing.

The downstream end of the annular discharge nozzle may have an annular axially extending slot and the upstream ends of the radially outer platforms of the turbine nozzle guide vanes locating in the annular axially extending slot in the downstream end of the annular discharge nozzle.

A wear resistant coating may be provided on the upstream ends of the radially outer platforms of the turbine nozzle guide vanes and/or a wear resistant coating may be provided on the surfaces of the annular axially extending slot in the downstream end of the annular discharge nozzle.

A seal may be provided between the downstream end of the annular discharge nozzle and the upstream ends of the radially outer platforms of the turbine nozzle guide vanes.

The upstream ends of the radially outer platforms of the turbine nozzle guide vanes may be positioned downstream of or abutting the downstream end of the annular discharge nozzle.

The seal may abut radially outer surfaces at the upstream ends of the radially outer platforms of the turbine nozzle guide vanes.

The seal may comprise a brush seal. The brush seal may comprise a plurality of bristles and the bristles being arranged at an angle between 15° and 75° to a radial direction.

The seal may comprise a bellows seal. The bellows seal may have an S-shape cross-section, a C-shape cross-section, a W-shape cross-section or an E-shape cross-section.

The seal may be located in an annular member and the annular member is U-shape in cross-section. The annular member may have an axially extending flange.

The axially extending flange of the annular member may be bonded, brazed or welded to the annular discharge nozzle.

The downstream end of the annular discharge nozzle may have an annular axially extending slot and the axially extending flange of the annular member locating in the annular axially extending slot in the downstream end of the annular discharge nozzle. The axially extending flange of the annular member may be bonded, brazed or welded to the annular discharge nozzle.

The annular member may be removably secured to the annular discharge nozzle. The annular member may have at least one L-shape member and the at least one L-shape member is removably secured to the annular discharge nozzle. The annular discharge nozzle may have at least one radially outwardly extending flange and the at least one L-shape member of the annular member is removably secured to the at least one radially outwardly extending flange of the annular discharge nozzle. The annular member may have a plurality of circumferentially spaced L-shape members and each L-shape member is removably secured to the annular discharge nozzle. The annular discharge nozzle may have at least one radially outwardly extending flanges and each L-shape member of the annular member is removably secured to the at least one radially outwardly extending flange of the annular discharge nozzle. The annular discharge nozzle may have a plurality of circumferentially spaced radially outwardly extending flanges and each L-shape member of the annular member is removably secured to a corresponding one of the radially outwardly extending flanges of the annular discharge nozzle.

The support structure allows relative radial movement between the annular casing and the annular discharge nozzle but provides axial stiffness between the annular casing and the annular discharge nozzle.

The support structure connecting the annular discharge nozzle and the annular casing may comprise at least one support member. The at least one support member may be integral with the annular discharge nozzle. The at least one support member may be bonded, brazed or welded to the annular discharge nozzle. The at least one support member may be J-shape in cross-section, U-shape in cross-section, S-shape in cross-section or W-shape in cross-section.

The at least one support member may comprise a first portion secured to the annular casing and a second portion secured to the annular discharge nozzle and the first and second portions are radially slidable relative to each other. The first portion of the at least one support member may be removably secured to the annular casing. The second portion of the at least one support member may be bonded, brazed or welded to the annular discharge nozzle. The first portion of the at least one support member may have a radial projection arranged to locate in a pocket, recess, in the second portion of the at least one support member. The second portion of the at least one support member may have a radial projection arranged to locate in a pocket, recess, in the first portion of the at least one support member.

The annular casing may comprise a casing portion, the casing portion has an axial end, the axial end of the casing portion has a radially outwardly extending flange, the radially outwardly extending flange has a radial face and a recess in the radial face, the first portion of the at least one support member locates in the recess in the radial face of the casing portion, the first portion of the at least one support member is removably secured to the radially outwardly extending flange and the second portion of the at least one support member is bonded, brazed or welded to the annular discharge nozzle

The at least one support member may be removably secured to the annular casing. The at least one support member may be integral with the annular discharge nozzle or may be bonded, brazed or welded to the annular discharge nozzle. The annular casing may have at least one radially inwardly extending flange and the at least one support member is removably secured to the at least one radially inwardly extending flange. The annular casing may comprise a casing portion, the casing portion has an axial end, the axial end of the casing portion has a radially outwardly extending flange, the radially outwardly extending flange has a radial face and a recess in the radial face, the at least one support member locates in the recess in the radial face of the casing portion and the support member is removably secured to the radially outwardly extending flange.

The support structure connecting the annular discharge nozzle and the annular casing may comprise a plurality of circumferentially spaced support members. Each of the plurality of support members may be integral with the annular discharge nozzle. Each of the plurality of support members may be bonded, brazed or welded to the annular discharge nozzle. Each of the plurality of support members may be J-shape in cross-section, U-shape in cross-section, S-shape in cross-section or W-shape in cross-section.

Each of the support members may comprise a first portion secured to the annular casing and a corresponding second portion secured to the annular discharge nozzle and the first and second portions are radially slidable relative to each other. The first portion of each of the support members may be removably secured to the annular casing. The second portion of each of the support members may be bonded, brazed or welded to the annular discharge nozzle. The first portion of each of the support members may have a radial projection arranged to locate in a pocket, recess, in the corresponding second portion of the support member. The second portion of each of the support members may have a radial projection arranged to locate in a pocket, recess, in the corresponding first portion of the support member.

Each of the support members may be removably secured to the annular casing. Each support member may be integral with the annular discharge nozzle or may be bonded, brazed or welded to the annular discharge nozzle. The annular casing may have at least one radially inwardly extending flange and each support member is removably secured to the at least one radially inwardly extending flange. The annular casing may have a plurality of circumferentially spaced radially inwardly extending flanges and each support member is removably secured to a corresponding one of the plurality of radially inwardly extending flanges. The annular casing may comprise a casing portion, the casing portion has an axial end, the axial end of the casing portion has a radially outwardly extending flange, the radially outwardly extending flange has a radial face and a plurality of circumferentially spaced recesses in the radial face, each support member locates in a corresponding one of the recesses in the radial face of the casing portion and each support member is removably secured to the radially outwardly extending flange.

The annular casing may comprise a casing portion, the casing portion has an axial end, the axial end of the casing portion has a radially outwardly extending flange, the radially outwardly extending flange has a radial face and a plurality of circumferentially spaced recesses in the radial face, the first portion of each support member locates in a corresponding recess in the radial face of the casing portion, the first portion of each support member is removably secured to the radially outwardly extending flange and the second portion of each support member is bonded, brazed or welded to the annular discharge nozzle.

The first portion of each support member may have circumferentially spaced stops and the corresponding second portion of each support member is located circumferentially between the circumferentially spaced stops. The second portion of each support member may have circumferentially spaced stops and the corresponding first portion of each support member is located circumferentially between the circumferentially spaced stops.

The present disclosure also provides a gas turbine engine having a gas turbine engine combustion arrangement. The gas turbine engine may be an aero gas turbine engine, a marine gas turbine engine, an industrial gas turbine engine or an automotive gas turbine engine. The aero gas turbine engine may be a turbofan gas turbine engine, a turbojet gas turbine engine, a turbo-shaft gas turbine engine or a turbo-propeller gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example only, with reference to the Figures, in which:

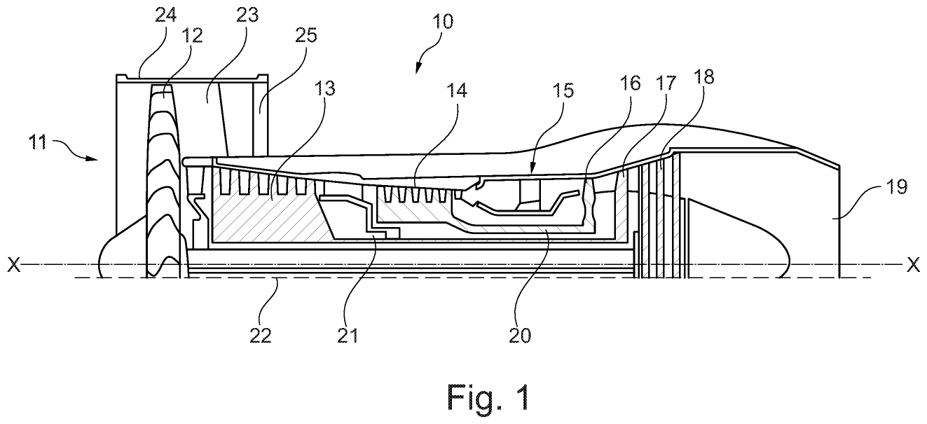

FIG. 1 is a sectional side view of a gas turbine engine.

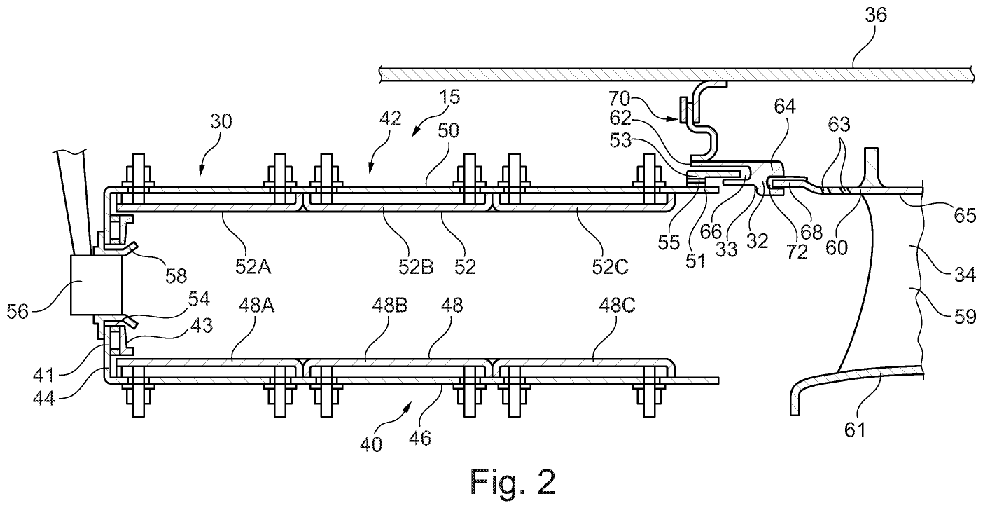

FIG. 2 is an enlarged cross-sectional view showing a combustion chamber, a discharge nozzle and an array of turbine nozzle guide vanes according to the present disclosure.

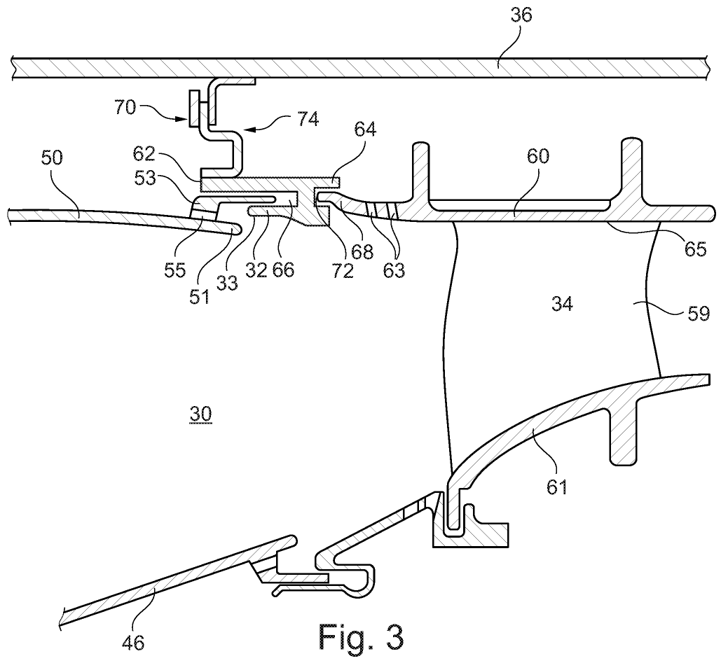

FIG. 3 is a further enlarged cross-sectional view of FIG. 2 showing the downstream end of the combustion chamber, the discharge nozzle and the array of turbine nozzle guide vanes according to the present disclosure.

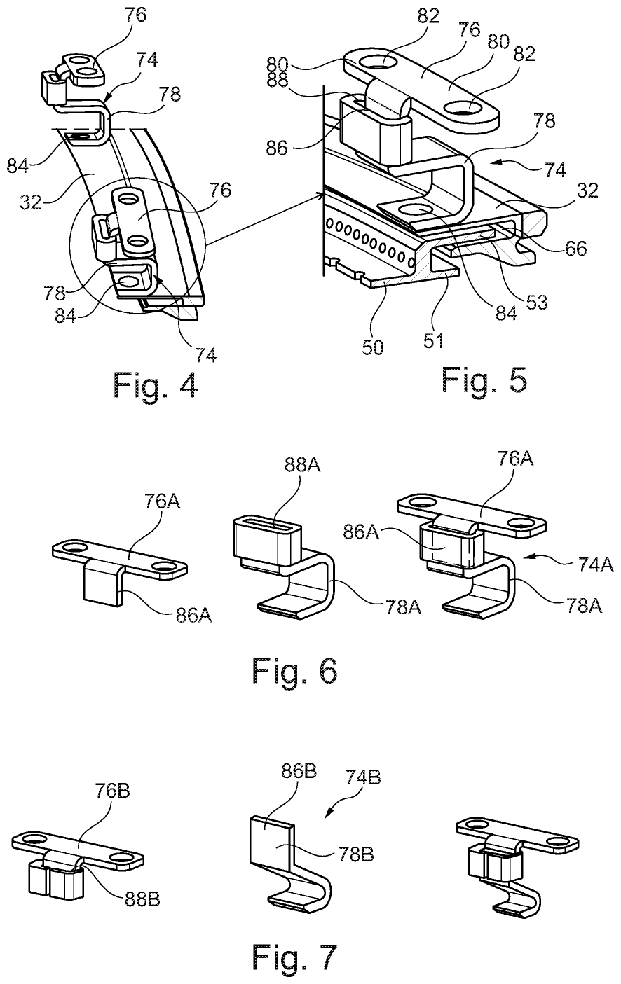

FIG. 4 is an enlarged perspective view of the discharge nozzle and support structures shown in FIG. 3.

FIG. 5 is a further enlarged perspective view of the support structure shown in FIG. 4.

FIG. 6 is an enlarged perspective view showing an alternative support structure.

FIG. 7 is an enlarged perspective view showing a further support structure.

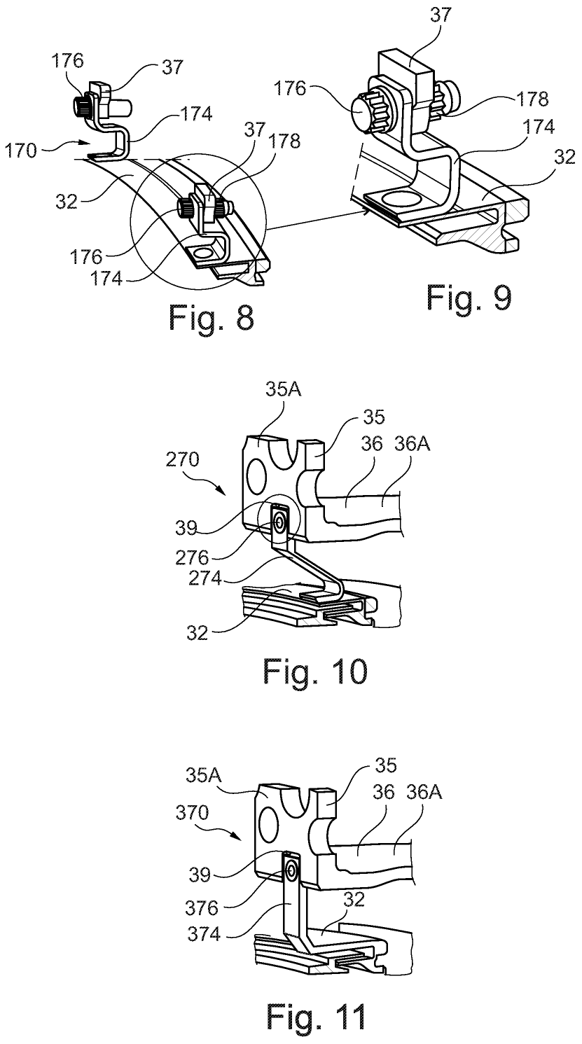

FIG. 8 is an enlarged perspective view of the discharge nozzle and alternative support structure.

FIG. 9 is a further enlarged perspective view of the support structure shown in FIG. 8.

FIG. 10 is an enlarged perspective view of the discharge nozzle and another support structure.

FIG. 11 an enlarged perspective view of the discharge nozzle and a further support structure.

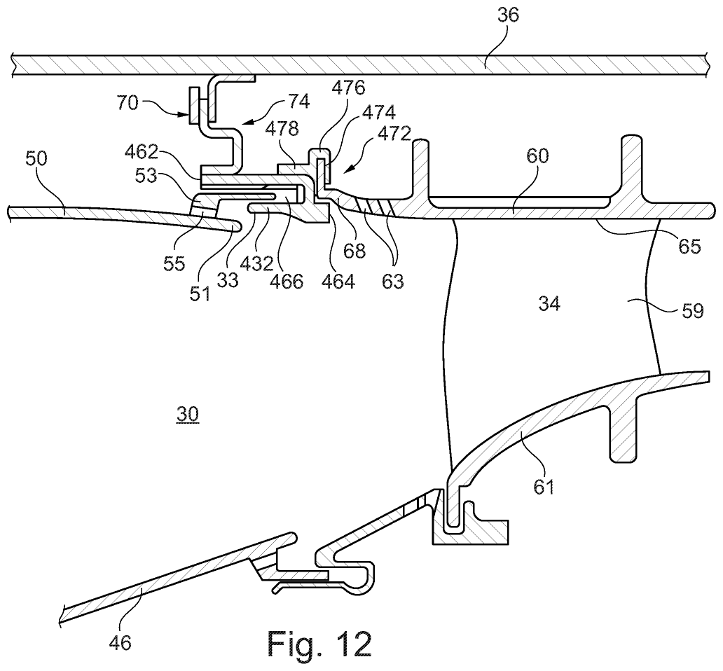

FIG. 12 is an enlarged cross-sectional view showing an alternative arrangement of the downstream end of a combustion chamber, a discharge nozzle and an array of turbine nozzle guide vanes according to the present disclosure.

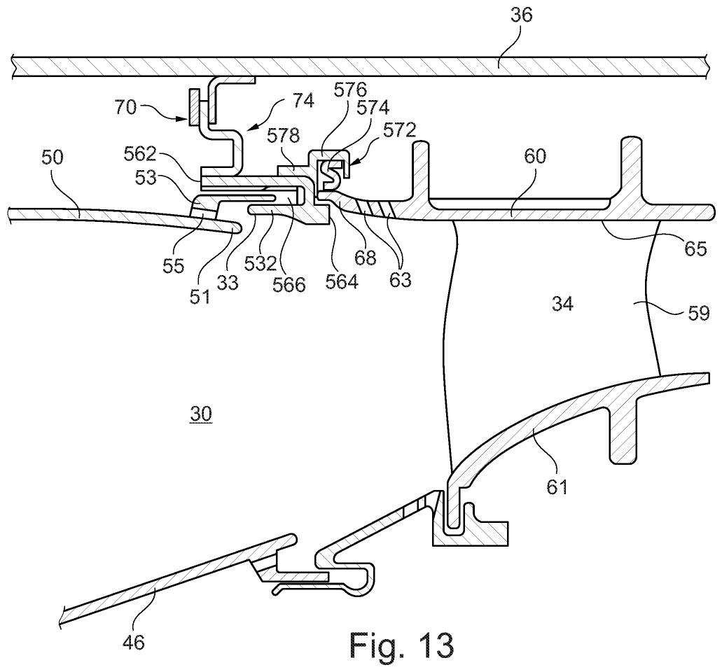

FIG. 13 is an enlarged cross-sectional view showing an a further arrangement of the downstream end of a combustion chamber, a discharge nozzle and an array of turbine nozzle guide vanes according to the present disclosure.

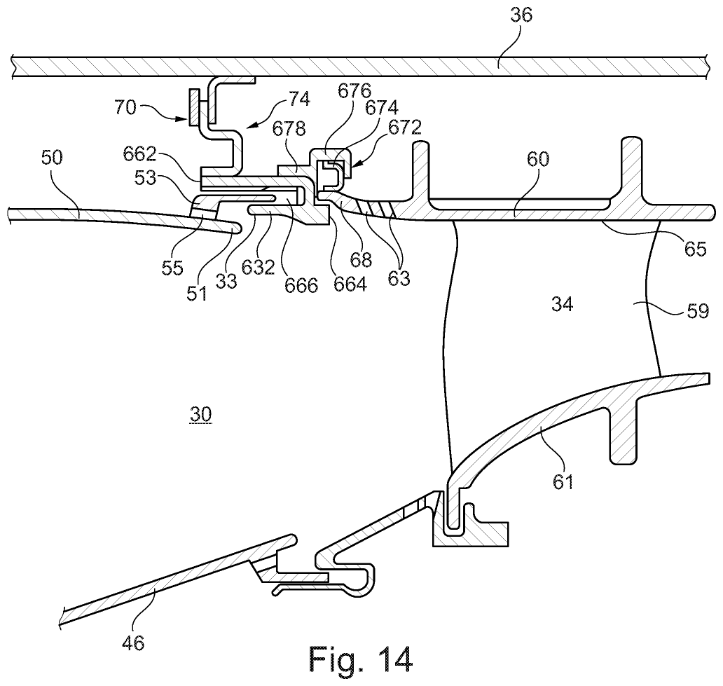

FIG. 14 is an enlarged cross-sectional view showing another arrangement of the downstream end of a combustion chamber, a discharge nozzle and an array of turbine nozzle guide vanes according to the present disclosure.

With reference to FIG. 1, a gas turbine engine is generally indicated at 10, having a principal and rotational axis X-X. The engine 10 comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and an exhaust nozzle 19. A fan nacelle 24 generally surrounds the fan 12 and defines the intake 11 and a fan duct 23. The fan nacelle 24 is secured to the core engine by fan outlet guide vanes 25.

The gas turbine engine 10 works in the conventional manner so that air entering the intake 11 is compressed by the fan 12 to produce two air flows: a first air flow into the intermediate pressure compressor 13 and a second air flow which passes through the bypass duct 23 to provide propulsive thrust. The intermediate pressure compressor 13 compresses the air flow directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high 16, intermediate 17 and low 18 pressure turbines drive respectively the high pressure compressor 14, the intermediate pressure compressor 13 and the fan 12, each by suitable interconnecting shaft 20, 21 and 22 respectively.

In particular, as shown in FIG. 2, the gas turbine engine 10 comprises combustion equipment 15 which includes an annular combustion chamber 30, an annular discharge nozzle 32, an array of turbine nozzle guide vanes 34 and an annular casing 36.

The annular combustion chamber 30 and comprises a radially inner annular wall structure 40, a radially outer annular wall structure 42 and an upstream end wall structure 44. The radially inner annular wall structure 40 comprises a first annular wall 46 and a second annular wall 48. The radially outer annular wall structure 42 comprises a third annular wall 50 and a fourth annular wall 52. The second annular wall 48 is spaced radially from and is arranged radially around the first annular wall 46 and the first annular wall 46 supports the second annular wall 48. The fourth annular wall 52 is spaced radially from and is arranged radially within the third annular wall 50 and the third annular wall 50 supports the fourth annular wall 52. The upstream end wall structure 44 comprises an upstream end wall 41 and a plurality of heat shields 43. The heat shields 43 are spaced axially from and are arranged axially downstream of the upstream end wall 41 and the upstream end wall 41 supports the heat shields 43. The upstream end of the first annular wall 46 is secured to the upstream end wall 41 of the upstream end wall structure 44 and the upstream end of the third annular wall 50 is secured to the upstream end wall 41 of the upstream end wall structure 44. The upstream end wall structure 44 has a plurality of circumferentially spaced apertures 54 and each aperture 54 extends through the upstream end wall 41 and a respective one of the heat shield 43. The combustion chamber 15 also comprises a plurality of fuel injectors 56 and a plurality of seals 58. Each fuel injector 56 is arranged in a corresponding one of the apertures 54 in the upstream end wall structure 44 and each seal 58 is arranged in a corresponding one of the apertures 54 in the upstream end wall structure 44 and each seal 58 is arranged around, e.g. surrounds, the corresponding one of the fuel injectors 56. The fuel injectors 56 are arranged to supply fuel into the annular combustion chamber 15 during operation of the gas turbine engine 10. The second annular wall 48 comprises a plurality of rows of combustion chamber tiles 48A, 48B and 48C and the fourth annular wall 52 comprises a plurality of rows of combustion chamber tiles 52A, 52B and 52C. The combustion chamber tiles 48A, 48B and 48C are secured onto the first annular wall 46 by threaded studs, washers and nuts and the combustion chamber tiles 52A, 52B and 52C are secured onto the third annular wall 50 by threaded studs, washers and nuts. The heat shields 43 are secured onto the upstream end wall 41 by threaded studs, washers and nuts. The heat shields 43 are arranged circumferentially side by side in a row.

The array of turbine nozzle guide vanes 34 comprises a plurality of circumferentially arranged turbine nozzle guide vanes 34 and each turbine nozzle guide vane 34 comprises an aerofoil portion 59, a radially outer platform 60 and a radially inner platform 61. The aerofoil portion 59, the radially outer platform 60 and the radially inner platform 61 of each turbine nozzle guide vane 34 are generally integral, e.g. form a monolithic structure. The turbine nozzle guide vanes 34 may be formed by casting or additive layer manufacture. The radially outer platforms 60 of the array of turbine nozzle guide vanes 34 have one or more rows of cooling apertures 63 extending there-through. The cooling apertures 63 are angled to provide a film of coolant on the inner surfaces 65 of the radially outer platforms 60 of the turbine nozzle guide vanes 34.

The third annular wall 50 of the radially outer annular wall structure 42 of the annular combustion chamber 30 has a downstream end 51, the array of turbine nozzle guide vanes 34 is located downstream of the annular combustion chamber 30 and the annular discharge nozzle 32 is located between the downstream end 51 of the third annular wall 50 of the annular combustion chamber 30 and the array of turbine nozzle guide vanes 34. The annular casing 36 surrounds and is spaced radially from the annular combustion chamber 30, the annular discharge nozzle 32 and the array of turbine nozzle guide vanes 34, e.g. the annular casing 36 surrounds and is spaced radially from the third annular wall 50 of the annular combustion chamber 30, the annular discharge nozzle 32 and the array of turbine nozzle guide vanes 34.

The annular discharge nozzle 32 has an upstream end 62 and a downstream end 64, the upstream end 62 of the annular discharge nozzle 32 has an annular axially extending slot 66, the downstream end 51 of the third annular wall 50 of the annular combustion chamber 30 locates in the annular axially extending slot 66 in the upstream end 62 of the annular discharge nozzle 32. The radially outer platforms 60 of the turbine nozzle guide vanes 34 have upstream ends 68, the upstream ends 68 of the radially outer platforms 60 of the turbine nozzle guide vanes 34 are positioned adjacent to the downstream end 64 of the annular discharge nozzle 32 and a support structure 70 is connected to the annular discharge nozzle 32 and the annular casing 36. In this example the downstream end 51 of the third annular wall 50 has a flange 53 which is L-shape in cross-section, and which extends radially outwardly and in an axially downstream direction. The portion of the flange 53 extending in an axially downstream direction, at the downstream end 51 of the third annular wall 50, locates in the axially extending slot 66 in the upstream end 62 of the annular discharge nozzle 32. The downstream end 64 of the annular discharge nozzle 32 has an annular axially extending slot 72 and the upstream ends 68 of the radially outer platforms 60 of the turbine nozzle guide vanes 34 locate in the annular axially extending slot 72 in the downstream end 64 of the annular discharge nozzle 32.

A wear resistant coating may be provided on the surfaces of the upstream ends 68 of the radially outer platforms 60 of the turbine nozzle guide vanes 34 and/or a wear resistant coating may be provided on the surfaces of the annular axially extending slot 72 in the downstream end 64 of the annular discharge nozzle 32. A wear resistant coating may be provided on the surfaces of the downstream end 51 of the third annular wall 50 of the annular combustion chamber 30 and/or a wear resistant coating may be provided on the surfaces of the annular axially extending slot 66 in the upstream end 62 of the annular discharge nozzle 32. A wear resistant coating may be provided on the surfaces of the portion of the flange 53 extending in an axially downstream direction, at the downstream end 51 of the third annular wall 50, and/or a wear resistant coating may be provided on the surfaces of the annular axially extending slot 66 in the upstream end 62 of the annular discharge nozzle 32. Sufficient clearance is provided between the downstream end 51 of the third annular wall 50, or the flange 53, and the annular axially extending slot 66 in the upstream end 62 of the annular discharge nozzle 32 to allow for relative movement between the annular combustion chamber 30 and the annular discharge nozzle 32 during normal operation of the gas turbine engine 10. Sufficient clearance is provided between the upstream ends 68 of the radially outer platforms 60 of the turbine nozzle guide vanes 34 and the annular axially extending slot 72 in the downstream end 64 of the annular discharge nozzle 32 to allow for relative movement between the turbine nozzle guide vanes 34 and the annular discharge nozzle 32 during normal operation of the gas turbine engine 10.

The flange 53 at the downstream end 51 of the third annular wall 50 is provided with a row of circumferentially spaced cooling apertures 55 and the cooling apertures 55 allow coolant to flow over the inner surface of the annular discharge nozzle 32 to provide a film of coolant on the inner surface 33 of the annular discharge nozzle 32 and on the inner surfaces 65 of the radially outer platforms 60 of the stage of turbine nozzle guide vanes 34.

The support structure 70 as shown more clearly in FIGS. 4 and 5 comprises a plurality of circumferentially spaced supports 74. Each support 74 comprises a first portion, or first member, 76 secured to the annular casing 36 and a second portion, or second member, 78 secured to the annular discharge nozzle 32 and the first and second portions, or members, 76 and 78 respectively are radially slidable relative to each other. The first portion 76 of each support 74 is removably secured to the annular casing 36. In this example the first portion 76 of each support 74 is T-shaped and is removably secured to the annular casing 36 by bolts, screws or other suitable fasteners which are inserted through apertures 82 provided in the parallel flanges 80 of the T-shaped support 74. The second portion 78 of each support 74 is bonded, brazed or welded 84 to the annular discharge nozzle 32, for example a butt weld and/or a plug weld, e.g. a butt weld and a plug weld or a butt weld, a plug weld and one or more fillet welds. The second portion 78 of each support 74 has a radial projection 86 arranged to locate in a pocket, recess, 88 in the first portion 76 of the corresponding support 74. The second portion 78 of each support 74 has a C-shaped cross section and the radial projection 86 extending from one end of the C. The first and second portions 76 and 78 of each support 74 together form an S-shaped support 74. The sliding joint between the first and second portions 76 and 78 of each support 74 allows for relative thermal expansion and contraction between the annular casing 36 and the annular discharge nozzle 32. The S-shaped supports 74 allow relative radial movement between the annular casing 36 and the annular discharge nozzle 32 but provide axial stiffness between the annular casing 36 and the annular discharge nozzle 32.

Alternatively, as shown in FIG. 6, the first portion 76A of each support 74A has a radial projection 86A arranged to locate in a pocket, recess, 88A in the second portion 78A of the corresponding support 74A and these supports 74A work in the same way as those shown in FIGS. 4 and 5. A further alternative support 74B, as shown in FIG. 7, is similar to that shown in FIGS. 4 and 5 and comprises a second portion 78B which has a J-shaped cross section and a radial projection 86B extending from the top of the J which locates in a pocket, recess, 88B in the first portion 76B of the corresponding support 74B. The first and second portions 76B and 78B again together form an S-shaped support 74B. A further alternative, is similar to FIG. 7, but provides the radial projection on the first support portion and the radial pocket, or recess, on the J-shaped second portion to form an S-shaped support.

It may be equally applicable to provide a single annular support which comprises a single annular first portion secured to the annular casing and a single annular second portion secured to the annular discharge nozzle and the first and second portions are radially slidable relative to each other. The second portion may have a C-shaped, or J-shaped, cross section. The first portion of the support may be removably secured to the annular casing. The second portion of the support member may be bonded, brazed or welded to the annular discharge nozzle. The first portion of the support member may have an annular radial projection arranged to locate in an annular pocket, annular recess, in the second portion of the support. Alternatively, the second portion of the support may have an annular radial projection arranged to locate in an annular pocket, annular recess, in the first portion of the support. In this arrangement it is necessary to provide one or more apertures through the annular support to allow a flow of coolant to the cooling apertures in the radially outer platforms of the turbine nozzle guide vanes. The sliding joint between the first and second portions of the single annular support allows for relative thermal expansion and contraction between the annular casing and the annular discharge nozzle. The first and second portions form an S-shaped support which allows relative radial movement between the annular casing and the annular discharge nozzle but provide axial stiffness between the annular casing and the annular discharge nozzle. Alternatively, it may be possible to have a single annular second portion which has a C-shaped, or J-shaped, cross section and a plurality of circumferentially spaced radial projections each one of which locates in a pocket, recess, in a corresponding one of a plurality of first portions of the support or a single annular second portion which has a C-shaped, or J-shaped, cross section and a plurality of circumferentially spaced pockets, recesses, each one of which receives a radial projection of a corresponding one of a plurality of first portions of the support.

Another support structure 170 as shown more clearly in FIGS. 8 and 9 comprises a plurality of circumferentially spaced supports 174 which connect the annular discharge nozzle 32 and the annular casing 36. Each support 174 is removably secured to the annular casing 36 and in particular is removably secured to a corresponding one of a plurality of radially inwardly extending projections 37. Each support 174 is removably secured to the corresponding radially inwardly extending projection 37 by a bolt, a screw or other suitable fastener 176 which is inserted through an aperture provided in the projection 37 and a cooperating nut 178. Each support 174 is bonded, brazed or welded to the annular discharge nozzle 32. Each projection 37 is an integral part of the annular casing 32, e.g. the projections 37 and the annular casing 32 are a monolithic structure. Each support 174 has a C-shaped, or J-shaped, cross-section and a radial projection and the fastener 176 passes through an aperture in the radial projection. It may be equally possible to provide a single annular support which has a C-shaped, or J-shaped, cross-section and an annular radial projection which is removably secured to each one of a plurality of radially inwardly extending projections or to an annular radially inwardly extending flange. The single annular support may be bonded, brazed or welded to the annular discharge nozzle. The support structure 170 allows relative radial movement between the annular casing and the annular discharge nozzle but provide axial stiffness between the annular casing and the annular discharge nozzle.

A further support structure 270 as shown in FIG. 10 comprises a plurality of circumferentially spaced supports 274 which connect the annular discharge nozzle 32 and the annular casing 36. The annular casing 36 comprise a casing portion 36A and the casing portion 36A has an axial end and the axial end of the casing portion 36A has a radially outwardly extending flange 35. The radially outwardly extending flange 35 has a radial face 35A and the radial face 35A has a plurality of circumferentially spaced recesses 39. Each support 274 is removably secured to the annular casing 36 and in particular is removably secured in a corresponding one of the plurality of circumferentially spaced recesses 39 in the radial face 35A of the flange 35. Each support 274 is removably secured in the corresponding one of the plurality of circumferentially spaced recesses 39 by a bolt, a screw or other suitable fastener 276 which is inserted into a threaded aperture provided in the recess 39 in the flange 35. Each support 274 is bonded, brazed or welded to the annular discharge nozzle 32. The flange 35 is an integral part of the annular casing 32, e.g. the flange 35 and the annular casing 32 are a monolithic structure. Each support 274 has a C-shaped, or J-shaped, cross-section and a radial projection and the fastener 276 passes through an aperture in the radial projection. It may be equally possible to provide a single annular support which has a C-shaped, or J-shaped, cross-section and an annular radial projection which is removably secured in a single annular recess in the radial face of the annular flange or has a plurality of radial projections each one of which locates in a corresponding one of the recesses in the radial face of the annular flange. The support structure 270 allows relative radial movement between the annular casing and the annular discharge nozzle but provide axial stiffness between the annular casing and the annular discharge nozzle. The single annular support may be bonded, brazed or welded to the annular discharge nozzle.

An additional support structure 370 as shown in FIG. 11 comprises a plurality of circumferentially spaced supports 374 which connect the annular discharge nozzle 32 and the annular casing 36. The arrangement is similar to that of FIG. 10. The annular casing 36 comprise a casing portion 36A and the casing portion 36A has an axial end and the axial end of the casing portion 36A has a radially outwardly extending flange 35. The radially outwardly extending flange 35 has a radial face 35A and the radial face 35A has a plurality of circumferentially spaced recesses 39. Each support 374 is removably secured to the annular casing 36 and in particular is removably secured in a corresponding one of the plurality of circumferentially spaced recesses 39 in the radial face 35A of the flange 35. Each support 374 is removably secured in the corresponding one of the plurality of circumferentially spaced recesses 39 by a bolt, a screw or other suitable fastener 376 which is inserted into a threaded aperture provided in the recess 39 in the flange 35. Each support 374 is integral with the annular discharge nozzle 32, e.g. the supports 374 and the annular discharge nozzle 32 are a monolithic structure. The flange 35 is an integral part of the annular casing 32, e.g. the flange 35 and the annular casing 32 are a monolithic structure. Each support 374 has an L-shaped, C-shaped, or J-shaped, cross-section and a radial projection and the fastener 376 passes through an aperture in the radial projection. The support structure 370 allows relative radial movement between the annular casing and the annular discharge nozzle but provide axial stiffness between the annular casing and the annular discharge nozzle.

FIG. 12 shows an alternative arrangement of the downstream end of a combustion chamber 15, a discharge nozzle 432 and an array of turbine nozzle guide vanes 34. The annular discharge nozzle 432 has an upstream end 462 and a downstream end 464, the upstream end 462 of the annular discharge nozzle 432 has an annular axially extending slot 466, the downstream end 51 of the third annular wall 50 of the annular combustion chamber 30 locates in the annular axially extending slot 466 in the upstream end 462 of the annular discharge nozzle 432. The radially outer platforms 60 of the turbine nozzle guide vanes 34 have upstream ends 68, the upstream ends 68 of the radially outer platforms 60 of the turbine nozzle guide vanes 34 are positioned adjacent to the downstream end 464 of the annular discharge nozzle 432 and a support structure 70 is connected to the annular discharge nozzle 432 and the annular casing 36. In this example the downstream end 51 of the third annular wall 50 has a flange 53 which is L-shape in cross-section, and which extends radially outwardly and in an axially downstream direction. The portion of the flange 53 extending in an axially downstream direction, at the downstream end 51 of the third annular wall 50, locates in the axially extending slot 466 in the upstream end 462 of the annular discharge nozzle 432. The upstream ends 68 of the radially outer platforms 60 of the turbine nozzle guide vanes 34 are positioned downstream of or abutting, the downstream end 464 of the annular discharge nozzle 432. A seal arrangement 472 is provided between the downstream end 464 of the annular discharge nozzle 432 and the upstream ends 68 of the radially outer platforms 60 of the turbine nozzle guide vanes 34. The seal arrangement 472 abuts the radially outer surfaces at the upstream ends 68 of the radially outer platforms 60 of the turbine nozzle guide vanes 34.

The seal arrangement 472 comprises a brush seal 474. The brush seal 474 is annular and comprises a plurality of bristles and the bristles are arranged such that they extend longitudinally at an angle between 15° and 75° to a radial direction. The brush seal 474 is carried by an annular member 476. The annular member 476 is U-shape in cross-section and the limbs of the U-shape annular member 476 extend radially. The annular member 476 has an axially extending flange 478. The brush seal 474 is located between the limbs of the U-shape annular member 476. The axially extending flange 478 of the annular member 476 is secured to the annular discharge nozzle 432 and in particular is bonded, brazed or welded to the annular discharge nozzle 432.

The support structure 70 is the same as that described with reference to FIGS. 3 to 5, but may be any of those described with reference to FIGS. 6 to 11. FIG. 13 shows an alternative arrangement of the downstream end of a combustion chamber 15, a discharge nozzle 532 and an array of turbine nozzle guide vanes 34. The annular discharge nozzle 532 has an upstream end 562 and a downstream end 564, the upstream end 562 of the annular discharge nozzle 532 has an annular axially extending slot 566, the downstream end 51 of the third annular wall 50 of the annular combustion chamber 30 locates in the annular axially extending slot 566 in the upstream end 562 of the annular discharge nozzle 432. The radially outer platforms 60 of the turbine nozzle guide vanes 34 have upstream ends 68, the upstream ends 68 of the radially outer platforms 60 of the turbine nozzle guide vanes 34 are positioned adjacent to the downstream end 564 of the annular discharge nozzle 532 and a support structure 70 is connected to the annular discharge nozzle 532 and the annular casing 36. In this example the downstream end 51 of the third annular wall 50 has a flange 53 which is L-shape in cross-section, and which extends radially outwardly and in an axially downstream direction. The portion of the flange 53 extending in an axially downstream direction, at the downstream end 51 of the third annular wall 50, locates in the axially extending slot 566 in the upstream end 562 of the annular discharge nozzle 532. The upstream ends 68 of the radially outer platforms 60 of the turbine nozzle guide vanes 34 are positioned downstream of or abutting, the downstream end 564 of the annular discharge nozzle 532. A seal arrangement 572 is provided between the downstream end 564 of the annular discharge nozzle 532 and the upstream ends 68 of the radially outer platforms 60 of the turbine nozzle guide vanes 34. The seal arrangement 572 abuts the radially outer surfaces at the upstream ends 68 of the radially outer platforms 60 of the turbine nozzle guide vanes 34. The seal arrangement 572 comprises a bellows seal 574. The bellows seal 574 is annular and the bellows seal 574 has an S-shape cross-section. The bellows seal 574 is carried by an annular member 576. The annular member 576 is U-shape in cross-section and the limbs of the U-shape annular member 576 extend radially. The annular member 576 has an axially extending flange 578. The bellows seal 574 is located between the limbs of the U-shape annular member 576. The axially extending flange 578 of the annular member 576 is secured to the annular discharge nozzle 532 and in particular is bonded, brazed or welded to the annular discharge nozzle 532.

The support structure 70 is the same as that described with reference to FIGS. 3 to 5, but may be any of those described with reference to FIGS. 6 to 11.

FIG. 14 shows another arrangement of the downstream end of a combustion chamber 15, a discharge nozzle 632 and an array of turbine nozzle guide vanes 34. The annular discharge nozzle 632 has an upstream end 662 and a downstream end 664, the upstream end 662 of the annular discharge nozzle 632 has an annular axially extending slot 666, the downstream end 51 of the third annular wall 50 of the annular combustion chamber 30 locates in the annular axially extending slot 666 in the upstream end 662 of the annular discharge nozzle 632. The radially outer platforms 60 of the turbine nozzle guide vanes 34 have upstream ends 68, the upstream ends 68 of the radially outer platforms 60 of the turbine nozzle guide vanes 34 are positioned adjacent to the downstream end 664 of the annular discharge nozzle 632 and a support structure 70 is connected to the annular discharge nozzle 632 and the annular casing 36. In this example the downstream end 51 of the third annular wall 50 has a flange 53 which is L-shape in cross-section, and which extends radially outwardly and in an axially downstream direction. The portion of the flange 53 extending in an axially downstream direction, at the downstream end 51 of the third annular wall 50, locates in the axially extending slot 666 in the upstream end 662 of the annular discharge nozzle 632. The upstream ends 68 of the radially outer platforms 60 of the turbine nozzle guide vanes 34 are positioned downstream of or abutting, the downstream end 664 of the annular discharge nozzle 632. A seal arrangement 672 is provided between the downstream end 664 of the annular discharge nozzle 632 and the upstream ends 68 of the radially outer platforms 60 of the turbine nozzle guide vanes 34. The seal arrangement 672 abuts the radially outer surfaces at the upstream ends 68 of the radially outer platforms 60 of the turbine nozzle guide vanes 34.

The seal arrangement 672 comprises a bellows seal 674. The bellows seal 674 is annular and the bellows seal 674 has a C-shape cross-section. The bellows seal 674 is carried by an annular member 676. The annular member 676 is U-shape in cross-section and the limbs of the U-shape annular member 676 extend radially. The annular member 676 has an axially extending flange 678.

The bellows seal 674 is located between the limbs of the U-shape annular member 676. The axially extending flange 678 of the annular member 676 is secured to the annular discharge nozzle 632 and in particular is bonded, brazed or welded to the annular discharge nozzle 632.

The support structure 70 is the same as that described with reference to FIGS. 3 to 5, but may be any of those described with reference to FIGS. 6 to 11.

In further alternative arrangements of the downstream end of the combustion chamber, the discharge nozzle and the array of turbine nozzle guide vanes, not shown, it may be possible to provide a seal arrangement with a W-shape cross-section or an E-shape cross-section or other suitable cross-section bellows seal in the U-shape annular member.

In variations of the arrangements of FIGS. 12, 13 and 14 the downstream end of the annular discharge nozzle may have an annular axially extending slot and the axially extending flange of the annular member locates in the annular axially extending slot in the downstream end of the annular discharge nozzle. The axially extending flange of the annular member is secured to the annular discharge nozzle, e.g. bonded, brazed or welded to the annular discharge nozzle.

In other variations of the arrangements of FIGS. 12, 13 and 14 the annular member may be removably secured to the annular discharge nozzle. The annular member may have at least one L-shape member and the at least one L-shape member is removably secured to the annular discharge nozzle. The annular discharge nozzle may have at least one radially outwardly extending flange and the at least one L-shape member of the annular member is removably secured to the at least one radially outwardly extending flange of the annular discharge nozzle. The annular member may have a plurality of circumferentially spaced L-shape members and each L-shape member is removably secured to the annular discharge nozzle. The annular discharge nozzle may have at least one radially outwardly extending flanges and each L-shape member of the annular member is removably secured to the at least one radially outwardly extending flange of the annular discharge nozzle. The annular discharge nozzle may have a plurality of circumferentially spaced radially outwardly extending flanges and each L-shape member of the annular member is removably secured to a corresponding one of the radially outwardly extending flanges of the annular discharge nozzle.

An advantage of the present disclosure is that it eliminates the radially extending flanges of the turbine nozzle guide vanes and the radially extending slot in the support structure and therefore they cannot become disengaged. It reduces the possibility of leakage of cooling air between the upstream ends of the radially outer platforms of the turbine nozzle guide vanes and the downstream end of the annular discharge nozzle. It is easier to assemble, or disassemble, the support structure onto the annular casing than onto the turbine nozzle guide vanes and this reduces the risk of damage to the support structure. It is not necessary to inspect the flanges of the turbine nozzle guide vanes to ensure they are located in the radially extending slot in the support structure. Furthermore, the support structure and discharge nozzle may be used many times increasing the service life and reducing the life cycle costs.

Although the present disclosure has been described with reference to an annular combustion chamber comprising an annular outer wall of the double skin arrangement in which a plurality of tiles are secured to the annular outer wall it may be equally possible for the annular outer wall to be of the single skin arrangement in which the annular outer wall does not have any tiles. The annular outer wall of the annular combustion chamber may also comprises a plurality of circumferentially arranged combustion chamber segments each of which extends the full length of the combustion chamber and each of which may have a single skin arrangement or a double skin arrangement.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The present disclosure also provides a gas turbine engine having a gas turbine engine combustion arrangement. The gas turbine engine may be an aero gas turbine engine, a marine gas turbine engine, an industrial gas turbine engine or an automotive gas turbine engine. The aero gas turbine engine may be a turbofan gas turbine engine, a turbojet gas turbine engine, a turbo-shaft gas turbine engine or a turbo-propeller gas turbine engine.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A gas turbine engine combustion arrangement comprising an annular combustion chamber, an annular discharge nozzle, an array of turbine nozzle guide vanes and an annular casing, the annular combustion chamber comprising an outer annular wall, the outer annular wall of the annular combustion chamber having a downstream end, the array of turbine nozzle guide vanes having radially outer platforms, the array of turbine nozzle guide vanes being located downstream of the annular combustion chamber, the annular discharge nozzle being located between the downstream end of the outer annular wall of the annular combustion chamber and the array of turbine nozzle guide vanes, the annular casing surrounding and being spaced radially from the annular combustion chamber, the annular discharge nozzle and the array of turbine nozzle guide vanes, the annular discharge nozzle having an upstream end and a downstream end, the upstream end of the annular discharge nozzle having an annular axially extending slot, the downstream end of the outer annular wall of the annular combustion chamber locating in the annular axially extending slot in the upstream end of the annular discharge nozzle, the radially outer platforms of the turbine nozzle guide vanes having upstream ends, the upstream ends of the radially outer platforms of the turbine nozzle guide vanes being positioned adjacent the downstream end of the annular discharge nozzle and a support structure being connected to the annular discharge nozzle and the annular casing.

2. A gas turbine engine combustion arrangement as claimed in claim 1 wherein the downstream end of the annular discharge nozzle has an annular axially extending slot and the upstream ends of the radially outer platforms of the turbine nozzle guide vanes locating in the annular axially extending slot in the downstream end of the annular discharge nozzle.

3. A gas turbine engine combustion arrangement as claimed in claim 2 wherein the annular axially extending slot in the downstream end of the annular discharge nozzle has surfaces, a wear resistant coating is provided on one of the upstream ends of the radially outer platforms of the turbine nozzle guide vanes and the surfaces of the annular axially extending slot in the downstream end of the annular discharge nozzle.

4. A gas turbine engine combustion arrangement as claimed in claim 1 wherein a seal is provided between the downstream end of the annular discharge nozzle and the upstream ends of the radially outer platforms of the turbine nozzle guide vanes.

5. A gas turbine engine combustion arrangement as claimed in claim 4 wherein the upstream ends of the radially outer platforms of the turbine nozzle guide vanes are positioned downstream of or abutting the downstream end of the annular discharge nozzle.

6. A gas turbine engine combustion arrangement as claimed in claim 4 wherein the seal abuts the radially outer surfaces at the upstream ends of the radially outer platforms of the turbine nozzle guide vanes.

7. A gas turbine engine combustion arrangement as claimed in claim 4 wherein the seal comprises a brush seal.

8. A gas turbine engine combustion arrangement as claimed in claim 7 wherein the brush seal comprises a plurality of bristles and the bristles are arranged at an angle between 15° and 75° to a radial direction.

9. A gas turbine engine combustion arrangement as claimed in claim 4 wherein the seal comprises a bellows seal, the bellows seal has one of an S-shape cross-section, a C-shape cross-section, a W-shape cross-section and an E-shape cross-section.

10. A gas turbine engine combustion arrangement as claimed in claim 4 wherein the seal is located in an annular member and the annular member is U-shape in cross-section.

11. A gas turbine engine combustion arrangement as claimed in claim 10 wherein the annular member has an axially extending flange, the downstream end of the annular discharge nozzle has an annular axially extending slot and the axially extending flange of the annular member locates in the annular axially extending slot in the downstream end of the annular discharge nozzle.

12. A gas turbine engine combustion arrangement as claimed in claim 11 wherein the annular member is removably secured to the annular discharge nozzle.

13. A gas turbine engine combustion arrangement as claimed in claim 12 wherein the annular member has at least one L-shape member and the at least one L-shape member is removably secured to the annular discharge nozzle.

14. A gas turbine engine combustion arrangement as claimed in claim 13 wherein the annular discharge nozzle has at least one radially outwardly extending flange and the at least one L-shape member of the annular member is removably secured to the at least one radially outwardly extending flange of the annular discharge nozzle.

15. A gas turbine engine a combustion arrangement as claimed in claim 13 wherein the annular member has a plurality of circumferentially spaced L-shape members and each L-shape member is removably secured to the annular discharge nozzle.

16. A gas turbine engine combustion arrangement as claimed in claim 15 wherein the annular discharge nozzle has at least one radially outwardly extending flange and each L-shape member of the annular member is removably secured to the at least one radially outwardly extending flange of the annular discharge nozzle.

17. A gas turbine engine combustion arrangement as claimed in claim 16 wherein the annular discharge nozzle has a plurality of circumferentially spaced radially outwardly extending flanges and each L-shape member of the annular member is removably secured to a corresponding one of the radially outwardly extending flanges of the annular discharge nozzle.

18. A gas turbine engine combustion arrangement as claimed in claim 1 wherein the support structure connecting the annular discharge nozzle and the annular casing comprises at least one support member, the at least one support member has one of a J-shape in cross-section, a U-shape in cross-section, a S-shape in cross-section and a W-shape in cross-section.

19. A gas turbine engine combustion arrangement as claimed in claim 18 wherein the support structure connecting the annular discharge nozzle and the annular casing comprises at least one support member, the at least one support member comprises a first portion secured to the annular casing and a second portion secured to the annular discharge nozzle and the first and second portions are radially slidable relative to each other, the first portion of the at least one support member has a radial projection arranged to locate in a pocket, recess, in the second portion of the at least one support member or the second portion of the at least one support member has a radial projection arranged to locate in a pocket, recess, in the first portion of the at least one support member.

20. A gas turbine engine combustion arrangement as claimed in claim 19 wherein the support structure connecting the annular discharge nozzle and the annular casing comprises at least one support member, the at least one support member comprises a first portion secured to the annular casing and a second portion secured to the annular discharge nozzle and the first and second portions are radially slidable relative to each other, the annular casing comprises a casing portion, the casing portion has an axial end, the axial end of the casing portion has a radially outwardly extending flange, the radially outwardly extending flange has a radial face and a recess in the radial face, the first portion of the at least one support member locates in the recess in the radial face of the casing portion, the first portion of the at least one support member is removably secured to the radially outwardly extending flange and the second portion of the at least one support member is bonded, brazed or welded to the annular discharge nozzle
